(19) United States
(12) Patent Application Publication
(10) Pub. No.: US 2025/0307578 A1
(43) Pub. Date: Oct. 2, 2025

(54) SMARTPHONE INCLUDING A RADIO FREQUENCY IDENTIFICATION (RFID) TERMINAL

(71) Applicant: T-Mobile USA, Inc., Bellevue, WA (US)

(72) Inventor: Chad Au, Kirkland, WA (US)

(21) Appl. No.: 18/617,429

(22) Filed: Mar. 26, 2024

(51) Int. Cl. G06K 7/10; G06Q 20/32

(52) U.S. Cl. CPC G06K 7/10386; G06Q 20/3278

(57) ABSTRACT

Techniques and architecture are described for integrating radio frequency identification (RFID) reader functionality into mobile communication devices, e.g., smartphones. By integrating RFID reader functionality into smartphones, which already have much of the RF equipment (transmitter, receiver, (transceiver), antenna), processing power, and connectivity needed as a self-contained, contactless-enabled, RFID terminal, prior art RFID terminal peripherals would become unnecessary. For example, integrated RFID terminal capabilities in smartphones may be used to conduct mobile contactless transactions, such as by tapping a credit card or debit card on the smartphone screen, much like when making purchases in stores today.

### BACKGROUND

The capabilities and uses of smartphones continue to grow exponentially as enabled by more powerful processors, sensors, and Fifth Generation (5G) (and beyond) technologies. Applications possible with smartphones are just about endless.

One of the benefits of mobile technology is enabling more opportunities for transactions on-the-go. An early example of an enabling technology for entrepreneurs to conduct secured business transactions wherever, including on the go, is a card reader that attaches to a mobile communication device, e.g., a smartphone. These are peripheral devices that must be connected to a smartphone physically or wirelessly, with some examples being based on RFID technology.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 schematically illustrates a portion of an example wireless communication network, according to some implementations.

FIG. 2 is a flow diagram illustrating an example process for conducting mobile contactless transactions using a radio frequency identification (RFID) terminal of a mobile communication device, according to some implementations.

FIG. 3 schematically illustrates a component level view of an example electronic device configured for use with the techniques and architecture described herein, according to some implementations.

FIG. 4 schematically illustrates a component level view of a server configured for use with the techniques and architecture described herein, according to some implementations.

### DETAILED DESCRIPTION

Described herein are techniques and architecture for integrating radio frequency identification (RFID) reader functionality into mobile communication devices, e.g., smartphones. By integrating RFID reader functionality into smartphones, which already have much of the RF equipment (transmitter, receiver, (transceiver), antenna), processing power, and connectivity needed as a self-contained, contactless-enabled, RFID terminal, prior art RFID terminal peripherals would become unnecessary. For example, integrated RFID terminal capabilities in smartphones may be used to conduct mobile contactless transactions, such as by tapping a credit card or debit card on the smartphone screen, much like when making purchases in stores today.

More particularly, the techniques and architecture described herein provide an integrated RFID terminal for mobile communication devices that supports inductive RFID tags. The integrated RFID terminal may be configured to operate over various standard RFID frequency bands. Features of the integrated RFID terminal are consistent with basic RFID terminals (e.g., the integrated RFID terminal is able to avoid clashes, such as when a wallet with other credit cards in close proximity is used as a case for the mobile communication device, e.g., a smartphone. The techniques and architecture described herein may be extended to provide an integrated RFID terminal extension to satellite phones where data services are supported to enable truly remote transactions where no cellular coverage exists.

Thus, in configurations, a mobile communication device includes a radio frequency identification (RFID) terminal. The RFID terminal is generally configured to read RFID tags that are located on or within various items. For example, the RFID terminal may be configured to read RFID tags within credit cards, debit cards, or other financial items. Reading of the RFID tags by the RFID terminal allows the mobile communication device to be utilized by a user in various financial transactions. The RFID terminal may read the tag for obtaining financial information from a credit card or debit card.

The financial information may be transmitted via the transceiver and antenna of the mobile communication device to a server (and/or other computing device) via the wireless communication network. The server may be located off-premises or on-premises. The financial information obtained from the credit card or debit card may be utilized and processed by the server such that a user of the mobile communication device pays for a service and/or product. The server (and/or other computing device) may send information, e.g., a payment confirmation or failure of payment, to the antenna and transceiver. The information may be displayed on the display and/or emitted by sound via the speaker.

Thus, the user may tap the credit card or debit card on (at least in close proximity to) the RFID terminal of the mobile communication device such that the RFID terminal reads the RFID tag of the credit card or debit card. In some instances, just having the credit card or debit card in close proximity to the RFID terminal of the mobile communication device is enough and physical tapping is not necessary. Additionally, there may be other ways for the RFID terminal to read the RFID tag.

In configurations, the RFID terminal of the mobile communication device may be utilized in other scenarios that include RFID tags. For example, attractions such as, for example, museums, zoos, etc. may include various items that are displayed. Such items may include RFID tags that a user may read with the RFID terminal of the mobile communication device. Thus, the mobile communication device may serve as a pseudo tour guide to display and/or audibly provide background information for the items on exhibit. This may be at an indoor or outdoor museum. In such scenarios, the RFID terminal may read an RFID tag and provide the signal via the transceiver and antenna to a server that, based on the information provided by the RFID tag provides the information back to the mobile communication device for display and/or audible emission of the information.

In another example scenario, the RFID terminal of the mobile communication device may be utilized within, for example, libraries. Books at the libraries may include RFID tags that may be read by the RFID terminal in order to check out books from the library by a user of the mobile communication device. Additionally, the RFID tags may be utilized to access and/or locate other (e.g., related) books through an App. The information from the RFID tag may be provided by the mobile communication device via the transceiver and antenna to a server (or other computing device) located within the library or off premises.

In another example scenario, hospitals may utilize RFID tags to track equipment, instruments, tools, etc. The mobile communication device may be utilized to read RFID tags on the equipment, instruments, tools, etc., which may then be provided via the transceiver and the antenna for tracking of the equipment, instruments, tools, etc. The information from the RFID tag may be provided by the mobile communication device via the transceiver and antenna to a server (or other computing device) located within the hospital or off premises.

In another example scenario, athletes may wear an RFID tag with which they may be timed when crossing a threshold. In some situations, the tag may need to be an active tag (e.g., a tag with a small battery) to be able to transmit a strong enough signal for the RFID terminal of the mobile communication device to pick up from a certain distance.

In another example scenario, microchip implants may be provided on pets, livestock, etc. The mobile communication device may utilize the RFID terminal to read the microchip implants, e.g., implanted RFID tags, to identify the pets, livestock, etc. In some configurations, the microchip implants may identify herds to which the livestock belongs.

Accordingly, as an example, a mobile communication device comprises an antenna and a transceiver coupled to the antenna. The mobile communication device also comprises a radio frequency identification (RFID) terminal coupled to the transceiver, wherein the RFID terminal is configured to read RFID tags to conduct mobile contactless transactions.

In configurations, the RFID terminal is configured to read RFID tags of at least one of credit cards or debit cards.

In configurations, the RFID terminal is configured to read RFID tags located at an attraction in order to serve as a tour guide of the attraction by providing information related to the attraction to a user of the mobile communication device.

In configurations, the attraction is one of a museum, a park, or a zoo.

In configurations, the RFID terminal is configured to read RFID tags located on books at a library to check out the books from the library by a user of the mobile communication device.

In configurations, the RFID terminal is configured to read RFID tags located on a participant of a sporting event.

In configurations, the RFID terminal is configured to read RFID tags located on at least one of pieces of equipment, instruments, or tools at a hospital.

In configurations, the RFID terminal is configured to read RFID tags located at least one of on or within an animal.

In configurations, the mobile communication device comprises one of a smartphone, a tablet, a laptop computer, or a satellite phone.

As another example, a method comprises reading, by a radio frequency identification (RFID) terminal of a mobile communication device, a RFID tag, wherein the RFID terminal is configured to read RFID tags to conduct mobile contactless transactions. The method also comprises transmitting, by a transceiver of the mobile communication device to an entity related to the RFID tag, signals from the RFID terminal based on reading the RFID tag. The method further comprises receiving, by the transceiver of the mobile communication device, information related to the RFID tag.

As a further example, a system within a mobile communication device comprises one or more processors and one or more non-transitory storage media comprising instructions stored thereon. The instructions are executable by the one or more processors to cause the one or more processors to perform one or more operations comprising reading, by a radio frequency identification (RFID) terminal of the mobile communication device, a RFID tag, wherein the RFID terminal is configured to read RFID tags to conduct mobile contactless transactions. The operations also comprise transmitting, by a transceiver of the mobile communication device to an entity related to the RFID tag, signals from the RFID terminal based on reading the RFID tag. The operations further comprise receiving, by the transceiver of the mobile communication device, information related to the RFID tag.

Accordingly, the techniques and architecture described herein provide for integrating radio frequency identification (RFID) reader functionality into mobile communication devices, e.g., smartphones. A smartphone RFID terminal renders prior art RFID peripheral devices obsolete for a more integrated device architecture. Such an architecture may allow for faster and more secure transactions. Software updates and development of feature enhancements may be eased since all hardware is within the control of the original equipment manufacturer (OEM) instead of separate manufacturers, reducing the likelihood of compatibility issues.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

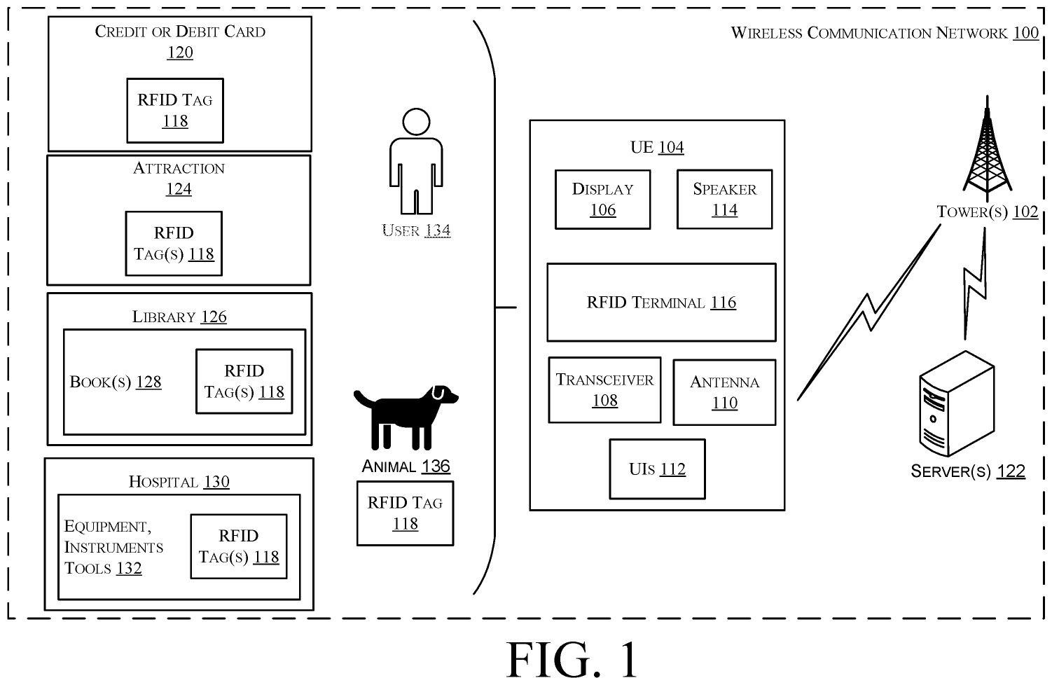

FIG. 1 schematically illustrates a portion of an example wireless communication network 100 that includes one or more tower(s) 102, as well as other types of signal transmission and receiving devices (not illustrated). The wireless communication network 100 communicates with various user equipment (UE) 104 in the form of electronic devices, e.g., smartphones, tablets, laptop computers, satellite phones, desktop computers, Internet of Things (IoT) devices, etc. Such electronic devices may communicate with the wireless communication network 100 wirelessly and/or via wired connections. Generally, smartphones, tablets, laptop computers, etc. are mobile and thus may be referred to as mobile communication devices.

In configurations, the UE 104 generally includes a display 106 that may also serve as a user input (UI), e.g., the display 106 may be interactive such as, for example, a touch screen. The UE 104 may also include a transceiver 108 and an antenna 110 coupled to the transceiver 108 for transmitting various wireless signals through the wireless communication network 100 and receiving wireless signals via the wireless communication network 100.

The UE 104 may also include one or more user inputs (UIs) 112 such as, for example, the keyboard, a touch pad, an interactive display (e.g., display 106), etc. The UE 104 may also include a speaker 114 that emits audible signals. The UE 104 may also include one or more processors and storage (memory), as will be described further herein. The storage may be utilized to store one or more applications (Apps). The UE 104 generally may also include other components not listed herein.

In configurations, the UE 104 includes a radio frequency identification (RFID) terminal 116. The RFID terminal 116 is generally configured to read RFID tags 118 that are located on or within various items. For example, the RFID terminal 116 may be configured to read RFID tags 118 within credit cards, debit cards, or other financial items (referred to herein as credit card or debit card 120). Reading of the RFID tags 118 by the RFID terminal 116 allows the UE 104 to be utilized by a user in various financial transactions. The RFID terminal 116 may read a RFID tag 118 for obtaining financial information from a credit card or debit card 120.

The financial information may be transmitted via the transceiver 108 and antenna 110 of the UE 104 to one or more server(s) 122 (and/or other computing device(s)) via the wireless communication network 100. The server(s) 122 (and/or other computing device(s)) may be located off-premises or on-premises. The financial information obtained from the credit card or debit card 120 may be utilized and processed by the server(s) 122 (and/or other computing device(s)) such that a user of the UE 104 pays for a service and/or product.

Thus, the user may tap the credit card or debit card 120 on (at least in close proximity to) the RFID terminal 116 of the UE 104 such that the RFID terminal 116 reads the RFID tag 118 of the credit card or debit card 120. In some instances, just having the credit card or debit card 120 in close proximity to the RFID terminal 116 of the UE 104 is enough and physical tapping is not necessary. Additionally, there may be other ways for the RFID terminal 116 to read the RFID tag 118. For example, the UE 104 may be configured so that the credit card or debit card 120 may be at least partially inserted into the UE 104 such that the RFID terminal 116 may read the RFID tag 118 of the credit card or debit card 120.

In configurations, the RFID terminal 116 of the UE 104 may be utilized in other scenarios that include RFID tags 118. For example, attractions 124 such as, for example, museums, zoos, etc. may include various items that are displayed. Such items may include RFID tags 118 that a user may read with the RFID terminal 116 of the UE 104. Thus, the UE 104 may serve as a pseudo tour guide to display and/or audibly provide background information for the items on exhibit. This may be at an indoor or outdoor museum. In such scenarios, the RFID terminal 116 may read an RFID tag 118 and provide the signal via the transceiver 108 and antenna 110 to the server(s) 122 (and/or other computing devices) that, based on the information provided by the RFID tag 118, provides the information back to the UE 104 for display and/or audible emission of the information.

In another example scenario, the RFID terminal 116 of the UE 104 may be utilized within, for example, a library 126. Books 128 at the library may include RFID tags 118 that may be read by the RFID terminal 116 in order to check out books 128 from the library 126 by a user of the UE 104. Additionally, the RFID tags 118 may be utilized to access and/or locate other (e.g., related) books 128 through an App. The information from the RFID tag 118 may be provided by the UE 104 via the transceiver 108 and antenna 110 to the server(s) 122 (and/or other computing device(s)) located within the library 126 or off premises.

In another example scenario, a hospital 130 may utilize RFID tags 118 to track pieces of equipment, instruments, tools, etc. 132. The UE 104 may be utilized to read RFID tags 118 on the equipment, instruments, tools, etc. 132, which may then be provided via the transceiver 108 and the antenna 110 for tracking of the equipment, instruments, tools, etc. 132. The information from the RFID tag 118 may be provided by the UE 104 via the transceiver 108 and antenna 110 to the server(s) 122 (and/or other computing device) located within the hospital 130 or off premises.

In another example scenario, a user 134, such as, for example, an athlete, may wear an RFID tag 118 with which they may be timed when crossing a threshold. In some situations, the RFID tag 118 may need to be an active tag (e.g., a RFID tag with a small battery) to be able to transmit a strong enough signal for the RFID terminal 116 of the UE 104 to pick up from a certain distance.

In another example scenario, a microchip implant in the form of a RFID tag 118 may be provided on an animal 136, e.g., pets, livestock, etc. The UE 104 may utilize the RFID terminal 116 to read the microchip implants, e.g., implanted RFID tags 118, to identify the pets, livestock, etc., 136. In some configurations, the microchip implants may identify herds to which the livestock belongs.

Another example use case includes protecting users from forgeries and fraud. For example, it is known that counterfeiters have passed fake gambling chips at casinos that were indistinguishable from real gambling chips. Thus, apps may be developed and downloaded onto UE 104 for specific venues or business establishments to ensure users are protected from forgeries/fraud. RFID tags 118 may be placed on items at venues or business establishments and then verified with the RFID terminal 116 of the UE 104.

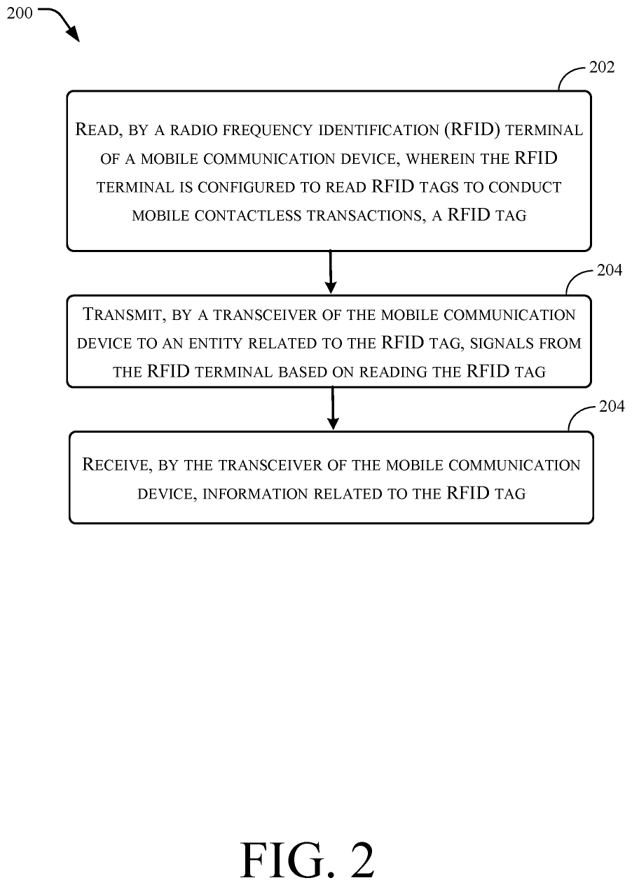

FIG. 2 is a flow diagram illustrating an example process, according to some implementations. The process is illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 for conducting mobile contactless transactions using a radio frequency identification (RFID) terminal of a mobile communication device. At 202, a radio frequency identification (RFID) terminal of a mobile communication device, reads a RFID tag, wherein the RFID terminal is configured to read RFID tags to conduct mobile contactless transactions. For example, the UE 104 includes a radio frequency identification (RFID) terminal 116. The RFID terminal 116 is generally configured to read RFID tags 118 that are located on or within various items. For example, the RFID terminal 116 may be configured to read RFID tags 118 within credit cards, debit cards, or other financial items (referred to herein as credit card or debit card 120). Reading of the RFID tags 118 by the RFID terminal 116 allows the UE 104 to be utilized by a user in various financial transactions. The RFID terminal 116 may read a RFID tag 118 for obtaining financial information from a credit card or debit card 120.

At 204, a transceiver of the mobile communication device transmits, to an entity related to the RFID tag, signals from the RFID terminal based on reading the RFID tag. For example, the financial information may be transmitted via the transceiver 108 and antenna 110 of the UE 104 to one or more server(s) 122 (and/or other computing device(s)) via the wireless communication network 100. The server(s) 122 (and/or other computing device(s)) may be located off-premises or on-premises. The financial information obtained from the credit card or debit card 120 may be utilized and processed by the server(s) 122 (and/or other computing device(s)) such that a user of the UE 104 pays for a service and/or product.

At 206, the transceiver of the mobile communication device receives information related to the RFID tag. For example, the server(s) 122 (and/or other computing device(s)) may send information, e.g., a payment confirmation or failure of payment, to the antenna 110 and transceiver 108 of the UE 104. The information may be displayed on the display 106 and/or emitted by sound via the speaker 114 of the UE 104.

Thus, the user may tap the credit card or debit card 120 on (at least in close proximity to) the RFID terminal 116 of the UE 104 such that the RFID terminal 116 reads the RFID tag 118 of the credit card or debit card 120. In some instances, just having the credit card or debit card 120 in close proximity to the RFID terminal 116 of the UE 104 is enough and physical tapping is not necessary. Additionally, there may be other ways for the RFID terminal 116 to read the RFID tag 118. For example, the UE 104 may be configured so that the credit card or debit card 120 may be at least partially inserted into the UE 104 such that the RFID terminal 116 may read the RFID tag 118 of the credit card or debit card 120.

UE 104 may be implemented as any suitable mobile computing device configured to communicate over a wireless and/or wireline network, including, without limitation, a mobile phone (e.g., a smart phone), a tablet computer, a laptop computer, a portable digital assistant (PDA), a wearable computer (e.g., electronic/smart glasses, a smart watch, fitness trackers, etc.), a networked digital camera, and/or similar mobile devices. Although this description predominantly describes the UE 104 as being “mobile” (i.e., configured to be carried and moved around), it is to be appreciated that the UE 104 may represent various types of communication devices that are generally stationary as well, such as televisions, desktop computers, game consoles, set top boxes, Internet of Things (IoT) devices, and the like. In this sense, the terms “communication device,” “wireless device,” “wireline device,” “mobile device,” “computing device,” and “user equipment (UE)” may be used interchangeably herein to describe any communication device capable of performing the techniques described herein. Furthermore, the UE 104 may be capable of communicating over wired networks, and/or wirelessly using any suitable wireless communications/data technology, protocol, or standard, such as Global System for Mobile Communications (GSM), Time Division Multiple Access (TDMA), Universal Mobile Telecommunications System (UMTS), Evolution-Data Optimized (EVDO), Long Term Evolution (LTE), Advanced LTE (LTE+), Generic Access Network (GAN), Unlicensed Mobile Access (UMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), High Speed Packet Access (HSPA), evolved HSPA (HSPA+), Voice over IP (VOIP), Voice over LTE (VOLTE), 5G, IEEE 802.1x protocols, WiMAX, Wi-Fi, and/or any future IP-based network technology or evolution of an existing IP-based network technology.

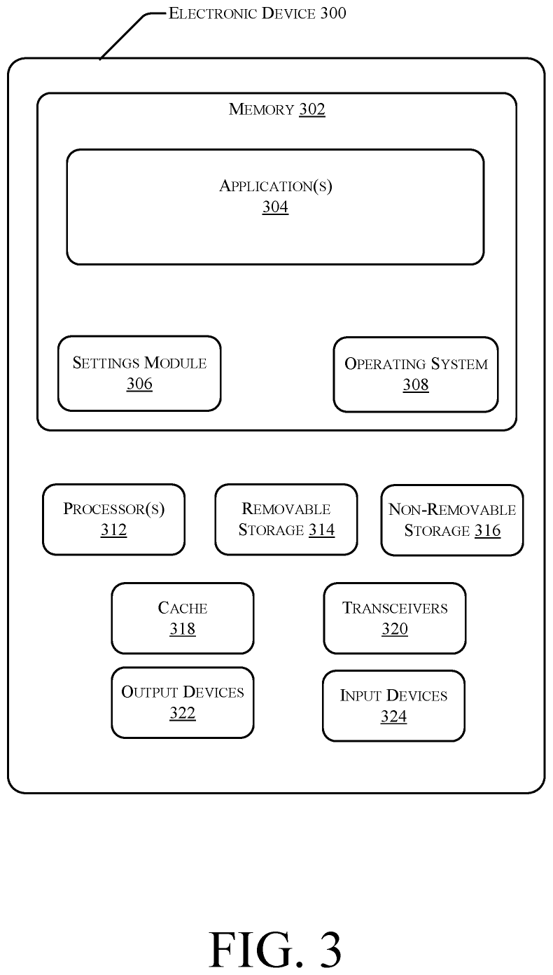

FIG. 3 schematically illustrates a component level view of a mobile device 300, such as UE 104, configured to function within wireless communication networks, e.g., wireless communication network 100. As illustrated, the mobile device 300 comprises a system memory 302, e.g., computer-readable media, storing application(s) 304, e.g., a call block/report application 326 that implements functions and UIs as described herein. Alternatively, the functions and UIs may be implemented, wholly or in part, via firmware (not illustrated). The mobile device also comprises a settings module 308, and an operating system 310. Also, the mobile device 300 includes processor(s) 312, a removable storage 314, a non-removable storage 316, cache 318, transceivers 320, output device(s) 322, and input device(s) 324. In various implementations, system memory 302 is volatile (such as RAM), non-volatile (such as ROM, flash memory, etc.) or some combination of the two. In some implementations, the processor(s) 312 is a central processing unit (CPU), a graphics processing unit (GPU), or both CPU and GPU, or any other sort of processing unit.

The mobile device 300 may also include additional data storage devices (removable and/or non-removable) such as, for example, magnetic disks, optical disks, or tape. Such additional data storage may include removable storage 314 and non-removable storage 316. Additionally, the mobile device 300 includes cache 318.

Non-transitory computer-readable media may include volatile and nonvolatile, removable and non-removable tangible, physical media implemented in technology for storage of information, such as computer readable instructions, data structures, program modules, or other data. System memory 302, removable storage 314, non-removable storage 316 and cache 318 are all examples of non-transitory computer-readable media. Non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other tangible, physical medium which can be used to store the desired information and which can be accessed by the mobile device 300. Any such non-transitory computer-readable media may be part of the mobile device 300. The processor(s) 312 may be configured to execute instructions, which may be stored in the non-transitory computer-readable media or in other computer-readable media accessible to the processor(s) 312.

In some implementations, the transceivers 320 include any sort of transceivers known in the art. For example, the transceivers 320 may include a radio transceiver that performs the function of transmitting and receiving radio frequency communications via an antenna (not shown). Also, or alternatively, the transceivers 320 may include wireless modem(s) to facilitate wireless connectivity with other computing devices. Further, the transceivers 320 may include wired communication components, such as an Ethernet port, for communicating with other networked devices.

In some implementations, the output devices 322 include any sort of output devices known in the art, such as a display (e.g., a liquid crystal display), speakers, a vibrating mechanism, or a tactile feedback mechanism. Output devices 322 also include ports for one or more peripheral devices, such as headphones, peripheral speakers, or a peripheral display.

In various implementations, input devices 324 include any sort of input devices known in the art. For example, input devices 324 may include a camera, a microphone, a keyboard/keypad, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like. The input devices 324 may be used to enter preferences of a user of the mobile device 300 to define how the user wishes certain calls from third parties to be handled by the wireless communication network, as previously described herein.

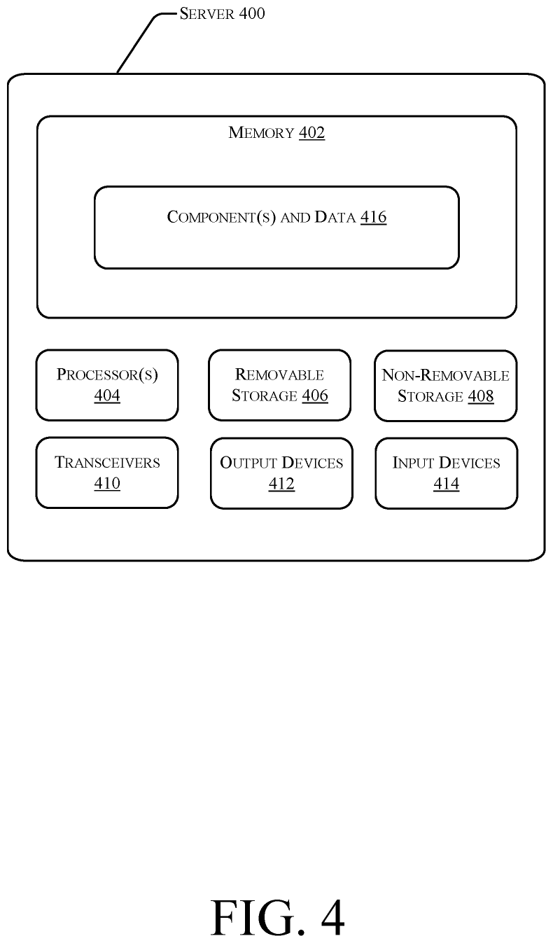

FIG. 4 illustrates a component level view of a server 400 configured for use within a wireless communication network, e.g., wireless communication network 100, in order to provide various services within the wireless communication network, according to the techniques described herein. For example, the server 400 may serve as a TAS or the server(s) 122, e.g., one or more servers 400 may be configured to serve as a TAS or the server(s) 122.

As illustrated, the server 400 comprises a system memory 402 that may store one or more components and/or applications and data 416 for interacting with mobile devices 300, e.g., UE 104, as described herein. Also, the server 400 may include processor(s) 404, a removable storage 406, a non-removable storage 408, transceivers 410, output device(s) 412, and input device(s) 414.

In various implementations, system memory 402 is volatile (such as RAM), non-volatile (such as ROM, flash memory, etc.), or some combination of the two. In some implementations, the processor(s) 404 is a Central Processing Unit (CPU), a Graphics Processing Unit (GPU), or both CPU and GPU, or any other sort of processing unit.

The server 400 may also include additional data storage devices (removable and/or non-removable) such as, for example, magnetic disks, optical disks, or tape. Such additional storage is illustrated in FIG. 4 by removable storage 406 and non-removable storage 408. The one or more of the memory 402, the removable storage 406 and/or the non-removable storage 408 may include module(s) and data 416 (illustrated in the memory 402). The module(s) and data 416 may include instructions executable by, for example, the processor(s) 404.

Non-transitory computer-readable media may include volatile and nonvolatile, removable and non-removable tangible, physical media implemented in technology for storage of information, such as computer readable instructions, data structures, program modules, or other data. System memory 402, removable storage 406 and non-removable storage 408 are all examples of non-transitory computer-readable media. Non-transitory computer-readable media include, but are not limited to, RAM, ROM, EEPROM, flash memory or other memory technology, CD-ROM, Digital Versatile Disks (DVD) or other optical storage, magnetic cassettes, magnetic tape, magnetic disk storage or other magnetic storage devices, or any other tangible, physical medium which can be used to store the desired information and which can be accessed by the server 400. Any such non-transitory computer-readable media may be part of the server 400.

In some implementations, the transceivers 410 include any sort of transceivers known in the art. For example, the transceivers 410 may include wired communication components, such as an Ethernet port, for communicating with other networked devices. Also, or instead, the transceivers 410 may include wireless modem(s) to facilitate wireless connectivity with other computing devices. Further, the transceivers 410 may include a radio transceiver that performs the function of transmitting and receiving radio frequency communications via an antenna.

In some implementations, the output devices 412 include any sort of output devices known in the art, such as a display (e.g., a liquid crystal display), speakers, a vibrating mechanism, or a tactile feedback mechanism. Output devices 412 also include ports for one or more peripheral devices, such as headphones, peripheral speakers, or a peripheral display.

In various implementations, input devices 414 include any sort of input devices known in the art. For example, input devices 414 may include a camera, a microphone, a keyboard/keypad, a computer mouse, or a touch-sensitive display. A keyboard/keypad may be a push button numeric dialing pad (such as on a typical telecommunication device), a multi-key keyboard (such as a conventional QWERTY keyboard), or one or more other types of keys or buttons, and may also include a joystick-like controller and/or designated navigation buttons, or the like.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 604 and memory 402 are examples of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1-3. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A mobile communication device comprising:
an antenna;
a transceiver coupled to the antenna; and
a radio frequency identification (RFID) terminal coupled to the transceiver, wherein the RFID terminal is configured to read RFID tags to conduct mobile contactless transactions.

2. The mobile communication device of claim 1, wherein the RFID terminal is configured to read RFID tags of at least one of credit cards or debit cards.

3. The mobile communication device of claim 1, wherein the RFID terminal is configured to read RFID tags located at an attraction in order to serve as a tour guide of the attraction by providing information related to the attraction to a user of the mobile communication device.

4. The mobile communication device of claim 3, wherein the attraction is one of a museum, a park, or a zoo.

5. The mobile communication device of claim 1, wherein the RFID terminal is configured to read RFID tags located on books at a library to check out the books from the library by a user of the mobile communication device.

6. The mobile communication device of claim 1, wherein the RFID terminal is configured to read RFID tags located on a participant of a sporting event.

7. The mobile communication device of claim 1, wherein the RFID terminal is configured to read RFID tags located on at least one of pieces of equipment, instruments, or tools at a hospital.

8. The mobile communication device of claim 1, wherein the RFID terminal is configured to read RFID tags located at least one of on or within an animal.

9. The mobile communication device of claim 1, wherein the mobile communication device comprises one of a smartphone, a tablet, a laptop computer, or a satellite phone.

10. A method comprising:
reading, by a radio frequency identification (RFID) terminal of a mobile communication device, wherein the RFID terminal is configured to read RFID tags to conduct mobile contactless transactions, a RFID tag;
transmitting, by a transceiver of the mobile communication device to an entity related to the RFID tag, signals from the RFID terminal based on reading the RFID tag; and
receiving, by the transceiver of the mobile communication device, information related to the RFID tag.

11. The method of claim 10, wherein:
the RFID tag is related to one of a credit card or a debit card; and
the information is related to a financial transaction of a user of the mobile communication device.

12. The method of claim 10, wherein:
the RFID tag is related to an attraction in order to serve as a tour guide of the transaction by providing the information; and
the information is related to the attraction.

13. The method of claim 12, wherein the attraction is one of a museum, a park, or a ZOO.

14. The method of claim 10, wherein:
the RFID tag is located on a book at a library; and
the information is related to checking out the book by a user of the mobile communication device.

15. The method of claim 10, wherein:
the RFID tag is located on a participant of a sporting event; and
the information is related to participation of the participant in the sporting event.

16. The method of claim 10, wherein:
the RFID tag is located on one of a piece of equipment, an instrument, or a tool at a hospital; and
the information is related to tracking of the one of the piece of equipment, the instrument, or the tool at the hospital.

17. The method of claim 10, wherein:
the RFID tag is located one of on or within an animal; and
the information is related to identity of one of the animal or a herd including the animal.

18. The method of claim 10, wherein the mobile communication device comprises one of a smartphone, a tablet, a laptop computer, or a satellite phone.

19. A system within a mobile communication device, the system comprising:
one or more processors; and
one or more non-transitory storage media comprising instructions stored thereon, the instructions being executable by the one or more processors to cause the one or more processors to perform one or more operations comprising:
reading, by a radio frequency identification (RFID) terminal of the mobile communication device, wherein the RFID terminal is configured to read RFID tags to conduct mobile contactless transactions, a RFID tag;
transmitting, by a transceiver of the mobile communication device to an entity related to the RFID tag, signals from the RFID terminal based on reading the RFID tag; and
receiving, by the transceiver of the mobile communication device, information related to the RFID tag.

20. The system of claim 19, wherein:
the RFID tag is related to one of a credit card or a debit card; and
the information is related to a financial transaction of a user of the mobile communication device.
